(19) United States
(12) Patent Application Publication
(10) Pub. No.: US 2006/0222926 A1
(43) Pub. Date: Oct. 5, 2006

(54) Fuel Cell

(75) Inventor: Yuusuke Sato, Bunkyo-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/370,041

(22) Filed: Mar. 8, 2006

(30) Foreign Application Priority Data
Mar. 29, 2005 (JP) 2005-096301

(51) Int. Cl. H01M 8/02; H01M 8/10

(52) U.S. Cl. 429/34; 429/38; 429/30

(57) ABSTRACT

A fuel cell is provided with: a membrane electrode assembly including an anode, a cathode and a proton-permeation membrane provided between the anode and the cathode; and a fuel supply path to supply a fuel including any of water-soluble organic matters to the anode, the fuel supply path including a back-diffusion barrier to prevent water from diffusion in a direction reverse to supply of the fuel.

### CROSS-REFERENCE TO RELATED APPLICATIONS

This application is based upon and claims the benefit of priority from the prior Japanese Patent Application No. 2005-096301 (filed Mar. 29, 2005); the entire contents of which are incorporated herein by reference.

### BACKGROUND OF THE INVENTION

1. Field of the Invention

The present invention relates to a fuel cell.

2. Description of the Related Art

A direct methanol fuel cell is in general provided with a membrane electrode assembly composed of an anode, a cathode and a proton-permeation membrane put therebetween. Methanol as a fuel, or a mixture of methanol and water, is supplied to the anode and air as an oxidizer is supplied to the cathode, to generate electricity. In the course of electricity generation, the anode generates carbon dioxide and the cathode generates water, respectively.

Methanol in the anode is in general diluted with water and preferably applied to the direct methanol fuel cell in concentrations of several M (mol/l).

The proton-permeation membrane serves as a medium which protons generated by an anodic reaction permeates to the cathode and is in general required to be humidified. As the water required for humidifying, water in the fuel and/or water generated in the cathode are employed.

Japanese Patent Application Laid-open No. 2004-146370 discloses an art of a direct methanol fuel cell.

Using more concentrated methanol as a fuel may be advantageous and it may be embodied by regulating a balance of water and methanol in the anode. Such a constitution provides an advantage of enabling to downsize a fuel tank with no reduction in the fuel cell capacity, but may cause diffusion driving force of back-diffusion of water in a direction reverse to supply of the fuel because a concentration of water in the fuel tank is smaller than that in the anode. Supposing the back-diffusion occurs, the concentration of the fuel in the fuel tank decreases and it gives rise to difficulty in regulation of the methanol aqueous solution in a constant concentration. To regulate the fuel supplied to the anode in a constant concentration so as to stabilize electromotive force, a fuel cell having a constitution to prevent the back-diffusion of water from the anode to the fuel tank is required.

The present invention is carried out in view of the above problem and intended for providing a fuel cell having a stable ability to generate electricity by preventing fluctuation in a fuel concentration caused by back-diffusion of water from the anode to a fuel tank.

### SUMMARY OF THE INVENTION

According to a first aspect of the present invention, a fuel cell is provided with: a membrane electrode assembly including an anode, a cathode and a proton-permeation membrane provided between the anode and the cathode; and a fuel supply path to supply a fuel including any of water-soluble organic matters to the anode, the fuel supply path including a back-diffusion barrier to prevent water from diffusion in a direction reverse to supply of the fuel.

According to a second aspect of the present invention, a fuel cell is provided with: a membrane electrode assembly to generate electricity from a fuel and an air, the membrane electrode assembly including an anode catalyst and a cathode catalyst; a fuel supply path to conduct a fuel including water at a controlled flow velocity u; and a back-diffusion barrier to control back-diffusion of water, the back-diffusion barrier being interposed to have a length L between the fuel supply path and the anode catalyst and satisfying an equation of u>D/L, where D is a diffusion coefficient of water in the fuel.

### BRIEF DESCRIPTION OF THE DRAWINGS

FIGS. 1A and 1B are schematic illustrations of a front view and a plan view of a fuel cell in accordance with a first embodiment of the present invention;

FIG. 2 is a schematic illustration showing a relation between a fuel supply path and a membrane electrode assembly in the fuel cell of the first embodiment of the present invention;

FIG. 3 is a graph illustrating a water concentration profile in a back-diffusion barrier layer in the fuel cell of the first embodiment of the present invention;

FIGS. 4A and 4B are schematic illustrations of a front view and a plan view of a fuel cell in accordance with a second embodiment of the present invention;

FIG. 5 is a schematic illustration showing a relation between a fuel supply path and a membrane electrode assembly in a fuel cell of a third embodiment of the present invention;

FIG. 6 is a schematic illustration showing a relation between a fuel supply path and a membrane electrode assembly in a fuel cell of a fourth embodiment of the present invention; and

FIG. 7 is a schematic illustration showing a relation between a fuel supply path and a membrane electrode assembly in a fuel cell of a fifth embodiment of the present invention.

### DETAILED DESCRIPTION OF THE INVENTION

Throughout the specification and claims, a term “back-diffusion” is defined and used as diffusion of a solute toward a direction opposed to a flow of a solvent.

As a fuel for a fuel cell in accordance with any embodiment of the present invention, any proper organic matters having water solubility mixed with water are preferable. As an example of such organic matters, methanol and dimethyl ether can be exemplified. An example in which a mixture of methanol and water is used as a fuel will be described hereinafter, however, of course, any other combinations of water soluble organic matters and water may be applied.

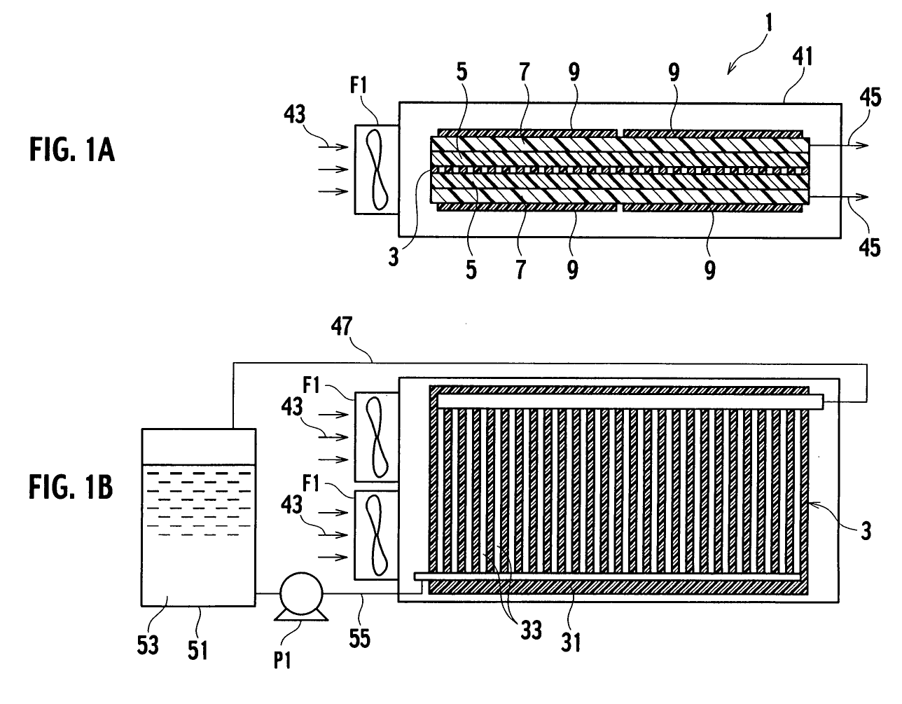

A first embodiment of the present invention will be described hereinafter with reference to FIGS. 1 through 3.

A fuel cell in accordance with the first embodiment of the present invention is, as shown in FIG. 1A, provided with a fuel distribution layer 3, a back-diffusion barrier layer 5 layered on the fuel distribution layer 3, an anode flow path 7 further layered on the back-diffusion barrier layer 5, and a membrane electrode assembly 9 layered on the anode flow path 7. FIG. 1A illustrates an example in which layers are one on one layered on both faces of the fuel distribution layer 3, but may be layered only on one of the faces.

The fuel distribution layer 3 is, as shown in FIG. 1B, provided with a distribution body 31 and a fuel distribution path 33 branched into plural ways to pass through the substantially whole face of the distribution body 31.

The back-diffusion barrier layer 5 is a thin plate-like layer made of carbon for example, which has a number of micro pores penetrating therethrough in the thickness direction. The micro pores are arranged at even intervals and in a grid pattern and serve as pathways for supplying the fuel to the anode flow path 7. The back-diffusion barrier layer 5, as having proper dimensions as described later, serves as a back-diffusion barrier for preventing water from diffusion toward a direction opposed to the supply of the fuel. The back-diffusion barrier layer 5 having a thickness of 2 mm and micro pores of 0.05 mm in diameter and arranged at even intervals of 1 cm is preferably applied, however, the thickness and the diameter may be properly selected based on the following description.

The anode flow path 7 has enough space to mix and dilute the fuel supplied from the back-diffusion barrier layer 5 with the water to be a uniform and proper concentration and makes the mixture uniformly diffuses into the membrane electrode assembly 9. Carbon dioxide generated at the membrane electrode assembly 9 passes through the anode flow path 7 and is exhausted from an exhaust 45. A gas-liquid separation membrane, through which gas is capable of passing though liquid is incapable of passing, may be interposed between the anode flow path 7 and the exhaust 45. Removal of carbon dioxide out of the membrane electrode assembly 9 by means of the anode flow path 7 promotes reactions at the membrane electrode assembly 9. Further, stirring caused by movement of the carbon dioxide gas contributes to keeping water and methanol in substantially constant concentrations.

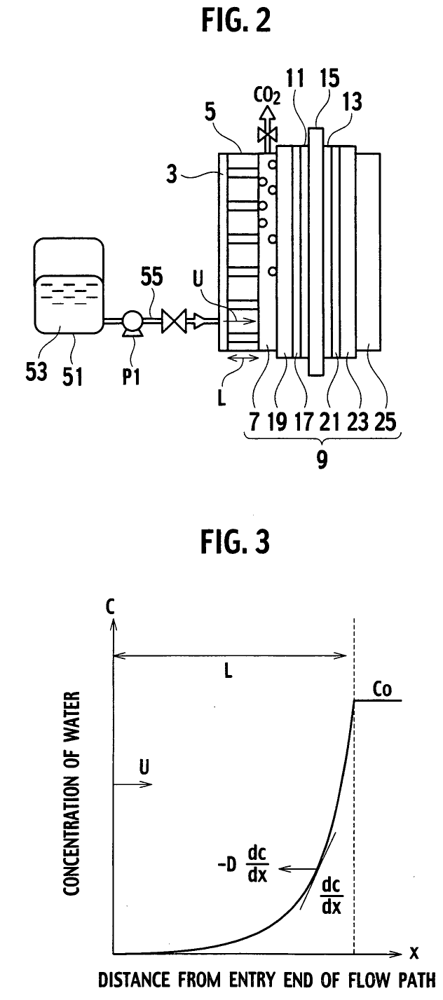

The membrane electrode assembly 9 is, as shown in FIG. 2, provided with an anode (fuel electrode) catalyst layer 11 faced to the anode flow path 7, a cathode (air electrode) catalyst layer 13 and a proton-permeation membrane 15 put therebetween. The proton-permeation membrane 15 is made of a synthetic resin having proton conductivity and water permeability. As such a resin, a copolymer of tetrafluoroethylene and perfluorovinyl ether sulfonate can be exemplified. This is commercially available under a trade name of “Nafion” (DuPont Corp.). Of course, any proper resin having proton conductivity and water permeability may be applied instead of this.

The membrane electrode assembly 9 is further provided with an anodemicro-porous layer 17 layered on the anode catalyst layer 11, an anode gas diffusion layer 19 further layered on the anode catalyst layer 11. The anode micro-porous layer 17 is a thin layer of about several tens microns in thickness, which is made of carbon having micro pores of about sub-micron in diameter and thereby serves as a diffusion barrier against diffusion of methanol from the anode gas diffusion layer 19 to the anode catalyst layer 11, which leads to reduction in methanol concentration in the anode catalyst layer 11 and thereby suppresses crossover of methanol from the anode catalyst layer 11 to the cathode catalyst layer 13. The anode gas diffusion layer 19 is a layer made of porous carbon paper and serves as a pathway to transport the fuel to the anode catalyst layer 11 and carbon dioxide to the anode flow path 7.

The membrane electrode assembly 9 may be further provided with a cathode micro-porous layer 21 layered on the cathode catalyst layer 13 and a cathode gas diffusion layer 23 further layered on the cathode micro-porous layer 21. The cathode micro-porous layer 21 is a thin layer of about several tens microns in thickness, which is made of carbon having micro pores of about sub-micron in diameter, and treated with a hydrophobicity treatment to increase hydrostatic pressure therein by a capillary force and transport water by the hydrostatic pressure from the cathode side to the anode side via the proton permeation membrane. The cathode gas diffusion layer 23 is a layer made of porous carbon paper.

The anode micro-porous layer 17 is treated with a hydrophilicity treatment in contrast with the cathode micro-porous layer 21 to decrease hydrostatic pressure therein by a capillary force. The anode micro-porous layer 17 cooperates with the cathode micro-porous layer 21 in promoting transport of water from the cathode side to the anode side.

The anode flow path 7 and the cathode flow path 25 are respectively provided with collectors (not shown) for collecting and extracting generated electricity to external power lines (not shown).

The fuel distribution layer 3, the back-diffusion barrier layer 5, the anode flow path 7 and the membrane electrode assembly 9 are housed in a casing 41 as shown in FIGS. 1A and 1B. A cathode flow path 25 as a proper clearance for enabling air circulation therein is held between the membrane electrode assembly 9 and an internal face of the casing 41. A ventilator F1 such as a fan is connected with an end of the casing 41 so as to introduce and circulate external air 43 in the casing 41.

The fuel cell 1 is further provided with a fuel supply path 55 in which a pump P1 intervenes, a recovery path 47 and a fuel tank 51 with which the paths 55 and 47 are respectively linked. The fuel supply path 55 is linked with an end of the fuel distribution path 33 of the fuel distribution layer 3 and the recovery path 47 is linked with another end thereof. The fuel tank 51 contains methanol aqueous solution 53 as the fuel. The methanol aqueous solution 53 preferably contains 25M (namely, pure) or less and 10M or more methanol and a proper content of water.

When operating the pump P1, the fuel flows through the fuel supply path 55 and branches to the respective branches of the fuel distribution path 33 to be supplied via the back-diffusion barrier layer 5, the anode flow path 7, the anode gas diffusion layer 19 and the anode micro-porous layer 17 to the anode catalyst layer 11. Simultaneously, the ventilator F1 is operated so that the air is delivered into the casing 41 to be supplied to the cathode catalyst layer 13 at a time of passing through the clearance around the membrane electrode assembly 9. The fuel cell 1 generates electricity by reacting the fuel and the air supplied as such. In the course of power generation, carbon dioxide is generated at the anode catalyst layer 11 and flows through the anode flow path 7 to be exhausted to the exterior as included in an exhaust 45. In this occasion, the air flow raised in the casing 41 by the ventilator F1 promotes discharge of the exhaust 45 to the exterior. In the meantime, water is generated at the cathode catalyst layer 13. A part of the water is exhausted to the exterior as accompanying the air flow in the casing 41 and another part moves to the anode side.

As described above, the water generated at the cathode catalyst layer 13 in part is capable of permeating the proton permeation membrane 15 and thereby moving to the anode catalyst layer 11. Albeit water tends to carry out back-diffusion to the fuel supply path 55 and further to the fuel tank 51 because the concentration of water in the cathode flow path is greater than the concentration of water in the methanol aqueous solution 53 in the fuel tank 51, the back-diffusion is suppressed by means of the back-diffusion barrier layer 5 as described below.

Provided that a flow of methanol having a constant flow speed u exists in a flow path as shown in FIG. 3, a flux uC(x) of water transported by the flow and an opposed flux−DdC(x)/dx of water by diffusion in a direction opposed to the flow are balanced with each other at any points in a steady state. Therefore, the following equation (1) can be formulated;

$$u \cdot C - D \frac{ⅆ C ( x )}{ⅆ x} = 0 , \qquad \text{-} ( 1 )$$

where D is a diffusion coefficient of water in methanol. Given that a length of the flow path is L and a concentration of water at an outflow end of the flow path has a constant value of C₀, a concentration C of water at an entry end (x=0) of the flow path can be represented by the following equation (2);

$$\frac{C}{{C}_{0}} = exp ( - \frac{u}{D} L ) \qquad \text{-} ( 2 )$$

As being understood from the equation (2), when u becomes greater as compared with D/L, the concentration of water at the entry end becomes smaller. DC/L represents a transfer speed of water by diffusion and uC represents a transfer speed of water by the flow. Provided that the transfer of water by diffusion is smaller than that by the flow, more specifically uC>CD/L, namely u>D/L, prevention of back-diffusion of water becomes sufficiently effective in view of practical use.

A constitution of the back-diffusion barrier layer 5 to produce the inequality of u>D/L will be described hereinafter.

The length L of the flow path is correspondent with the thickness of the back-diffusion barrier layer 5 as the fuel flows through the back-diffusion barrier layer 5 in the thickness direction. Six electrons are extracted per one molecule of methanol as the anodic reaction is represented by CH₃OH+H₂O→CO₂+6H⁺+6e⁻. More specifically, when a current i per unit area is extracted by the power generation, a molar number of methanol exhausted by the anodic reaction is i/6F. Therefore, a volume flux of methanol per unit area required at the membrane electrode assembly 9 can be represented by the following equation (3);

$${q}_{CH3OH\_reaction} = \frac{i}{6 F} \frac{M}{ρ} , \qquad \text{-} ( 3 )$$

where F represents a Faraday constant, M a molecular weight of methanol and ρ a specific gravity of methanol. Here, considering that methanol is in part lost to move to the cathode by crossover, the above equation should be modified. As a result, a volume flux of methanol per unit area required at the membrane electrode assembly 9 is represented by the following equation (4);

$${q}_{CH3OH\_total} = \frac{1}{( 1 - β )} \frac{i}{6 F} \frac{M}{ρ} , \qquad \text{-} ( 4 )$$

where β represents a ratio of a flux of methanol moving to the cathode by crossover to a summation of fluxes of methanol contributing to the anodic reaction and moving to the cathode.

As described above, the back-diffusion barrier layer 5 has a number of micro pores penetrating therethrough in the thickness direction. A flow speed of methanol is represented by the following equation (5);

$$u = \frac{4 q}{n {πϕ}^{2}} = \frac{4}{n π {ϕ}^{2}} \frac{1}{( 1 - β )} \frac{i}{6 F} \frac{M}{ρ} , \qquad \text{-} ( 5 )$$

where n represents the number of the micro pores per unit area and Φ a diameter.

Therefore, the value of u can be controlled by properly configuring the micro pores to set Φ in an appropriate value with respect to the values of i and β, which may be actually measured, and hence it can be configured to satisfy the inequality of u>D/L. In a case where the fuel is diluted with water, the flow velocity of the whole of the fuel can be estimated by adding a contribution of a volume flux of water to the equation (5).

Here, suppose that methanol of 100% in concentration is used as the fuel, a current density i=150 mA/cm² and a crossover ratio β=20%, and when micro pores of a diameter Φ=0.05 mm are arranged at even intervals of 1 cm, the equation (5) gives the flow velocity u=0.47 cm/s because of the molecular weight M=32 g/mol of methanol and its specific gravity ρ=0.79 g/cc. In the meantime, because a diffusion coefficient D of water in methanol is about 3×10⁻⁵ cm²/s, the thickness L=2 mm leads to D/L=1.5×10⁻⁴ cm/s. Therefore, u>D/L is satisfied.

The aforementioned values of i, β, L, Φ are provided for only illustration and may be properly selected based on the above description. Further, though the aforementioned description gives an example in which the back-diffusion barrier layer 5 has a number of micro pores penetrating therethrough in the thickness direction, it may be appropriately configured to satisfy the relation u>D/L by substantially regulating the length L of the flow path and the flow velocity u. Modifications and variations of the aforementioned embodiment may occur, for example using spaces between particles of a compressed powder body as the flow path.

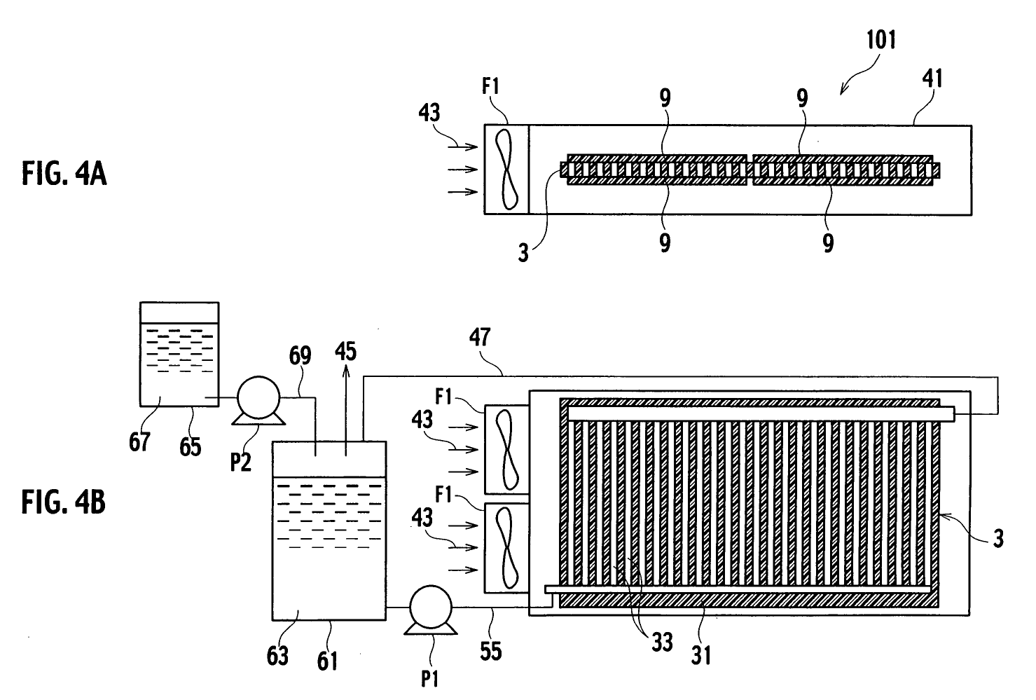

Next, a second embodiment of the present invention will be described hereinafter with reference to FIG. 4. In the following description, substantially the same elements as any of the aforementioned elements are referenced with the same numerals and the detailed descriptions are omitted.

In a fuel cell 101 in accordance with the second embodiment, the membrane electrode assembly 9 is directly layered on the fuel distribution layer 3. Moreover, instead of the fuel tank 51, a mixing tank 61 is linked with the fuel supply path 55 and the recovery path 47. A fuel tank 65 is linked with the mixing tank 61 via a fuel replenishment path 69 in which a pump 61 intervenes. The fuel tank 65 contains methanol aqueous solution 67 containing 25M (namely, pure) or less and 10M or more methanol and a proper water content as the fuel. The mixing tank 61 contains methanol aqueous solution 63 having a concentration proper for a power generation, such as a concentration of 3M.

When operating the pump P1, the methanol aqueous solution 63 as the fuel flows through the fuel supply path 55 and branches the respective branches of the fuel distribution path 33 to be supplied to the anode catalyst layer 11. Simultaneously, the ventilator F1 is operated so that the air is delivered into the casing 41 to be supplied to the cathode catalyst layer 13 at a time of passing through the clearance around the membrane electrode assembly 9. The fuel cell 1 generates electricity by reacting the fuel and the air. Carbon dioxide generated at the anode catalyst layer 11 in the course of the power generation is exhausted to the exterior as included in an exhaust 45 from the mixing tank 61. A part of water generated at the cathode catalyst layer 13 is exhausted to the exterior as accompanying the air flow in the casing 41.

The water generated at the cathode catalyst layer 13 in part is capable of moving to the anode catalyst layer 11 as described above. The water moving from the cathode to the anode, unreacted methanol and unreacted water are recycled via the recovery path 47 to the mixing tank 61. The pump P2 is operated to replenish the mixing tank 61 with the methanol aqueous solution 67 so as to balance exhausted methanol. A ratio of methanol and water in the methanol aqueous solution 67 contained in the fuel tank 65 is in advance regulated to be substantially the same as the ratio of methanol and water supplied to the membrane electrode assembly 9 via the fuel distribution layer 3. More specifically, methanol and water is supplied from the fuel tank 65 to the mixing tank 61 so as to correspond with exhausted methanol and water, thereby the ratio of methanol and water contained in the mixing tank 61 is kept substantially constant.

To the pump P2, any pump capable of closing the fuel replenishment path 69 between the fuel tank 65 and the mixing tank 61 at a time of shut-down is applied, such as a diaphragm pump or a tube pump. Alternatively, a non-closable pump such as a turbo pump in combination with a nonreturn valve 59 may be applied so that the valve 59 closes the fuel supply path 69 when the non-closable pump is shut down.

A concentration of water in the methanol aqueous solution 67 is less than a concentration of water in the methanol aqueous solution 63. Therefore, if the fuel tank 65 and the mixing tank 61 are directly linked, back-diffusion of water may occur. However, in accordance with the present embodiment, the pump P2 intervenes between the fuel tank 65 and the mixing tank 61 to prevent back-diffusion of water. Therefore the concentration of methanol is free from fluctuation by the back-diffusion of water to the fuel tank 65, thereby power generation by the fuel cell is stabilized.

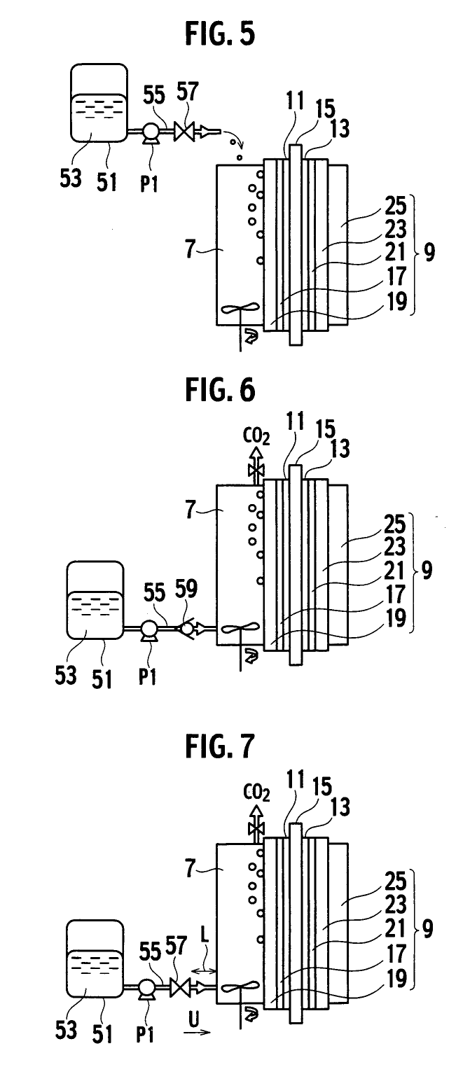

Next, a third embodiment of the present invention will be described hereinafter with reference to FIG. 5. In the following description, substantially the same elements as any of the aforementioned elements are referenced with the same numerals and the detailed description are omitted.

In the present embodiment, the fuel distribution layer 3 and the back-diffusion barrier layer 5 are omitted and the fuel supply path 55 is spatially separated from the anode flow path 7. The fuel supply path 55 is further provided with a throttle valve 57 to discharge the fuel as droplets from an end thereof with regulating a flow rate of the fuel. The spatial relation between the end of the fuel supply path 55 and the anode flow path 7 is such that the droplets are capable of directly reaching the anode flow path 7. Because the fuel supply path 55 is not directly connected to the anode flow path 7, water is incapable of back-diffusion toward a direction opposed to the supply of the fuel. Thereby the back-diffusion of the water is prevented.

Next, a fourth embodiment of the present invention will be described hereinafter with reference to FIG. 6. In the following description, substantially the same elements as any of the aforementioned elements are referenced with the same numerals and the detailed descriptions are omitted.

In the present embodiment, the fuel distribution layer 3 and the back-diffusion barrier layer 5 are omitted and the fuel supply path 55 is directly connected to the anode flow path 7. The fuel supply path 55 is further provided with a nonreturn valve 59. The nonreturn valve 59 prevents back-diffusion of water.

Next, a fifth embodiment of the present invention will be described hereinafter with reference to FIG. 7. In the following description, substantially the same elements as any of the aforementioned elements are referenced with the same numerals and the detailed descriptions are omitted.

In the present embodiment, the fuel distribution layer 3 and the back-diffusion barrier layer 5 are omitted and the fuel supply path 55 is directly connected to the anode flow path 7. The fuel supply path 55 is further provided with a throttle valve 57. By regulating the throttle valve 57, a flow velocity U downstream of the throttle valve 57 can be controlled and hence a relation represented by an equation of U>D/L can be satisfied, where L is a length of a part of the fuel supply path downstream of the throttle valve 57. Here D is a diffusion coefficient of water in methanol. As being understood from the aforementioned equation (2) and the description, back-diffusion of water is sufficiently suppressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents. For example, the fuel is not limited to the mixture of methanol and water and a mixture of any organic matters and water may be applied. Moreover, it is naturally permitted that the fuel contains any unavoidable or intended impurities excluding the organic matters and the water. The fuel may be supplied in either a liquid state or a gaseous state, for example, the fuel may be supplied in a gaseous state of a mixture of vapor of dimethyl ether and steam.

What is claimed is:

1. A fuel cell comprising:
a membrane electrode assembly including an anode, a cathode, and a proton-permeation membrane provided between the anode and the cathode; and
a fuel supply path to supply a fuel including any of water-soluble organic matters to the anode, the fuel supply path including a back-diffusion barrier to prevent water from diffusion in a direction reverse to supply of the fuel.

2. The fuel cell of claim 1, wherein the back-diffusion barrier includes a back-diffusion barrier layer configured to satisfy a relation represented by an equation of u>D/L, where u is a flow velocity of the fuel, D is a diffusion coefficient of water in the fuel and L is a thickness of the back-diffusion barrier layer.

3. The fuel cell of claim 1, wherein the back-diffusion barrier includes a throttle valve to inject the fuel as droplets and is spatially separated from the anode.

4. The fuel cell of claim 1, wherein the back-diffusion barrier includes a nonreturn valve.

5. The fuel cell of claim 1, wherein the back-diffusion barrier includes a throttle valve provided in the fuel supply path, the throttle valve and the fuel supply path being configured to satisfy a relation represented by an equation of U>D/L, where U is a flow velocity of the fuel, D is a diffusion coefficient of water in the fuel and L is a length of the fuel supply path where is downstream of the throttle valve.

6. The fuel cell of claim 1, wherein the fuel is liquid.

7. The fuel cell of claim 1, wherein the fuel includes any of alcohols.

8. The fuel cell of claim 1, wherein the fuel includes methanol.

9. The fuel cell of claim 1, wherein the fuel includes dimethyl ether.

10. A fuel cell comprising:
a membrane electrode assembly to generate electricity from a fuel and an air, the membrane electrode assembly including an anode catalyst and a cathode catalyst;
a fuel supply path to conduct a fuel including water at a controlled flow velocity u; and
a back-diffusion barrier to control back-diffusion of water, the back-diffusion barrier being interposed to have a length L between the fuel supply path and the anode catalyst and satisfying an equation of u>D/L, where D is a diffusion coefficient of water in the fuel.

11. The fuel cell of claim 10, wherein the back-diffusion barrier includes a back-diffusion barrier layer.

12. The fuel cell of claim 10, wherein the back-diffusion barrier includes a nonreturn valve.

13. The fuel cell of claim 10, wherein the back-diffusion barrier includes a throttle valve.

14. The fuel cell of claim 10, wherein the fuel is liquid.

15. The fuel cell of claim 10, wherein the fuel includes any of alcohols.

16. The fuel cell of claim 10, wherein the fuel includes methanol.

17. The fuel cell of claim 10, wherein the fuel includes dimethyl ether.
